(19) United States
(12) Patent Application Publication
(10) Pub. No.: US 2012/0098514 A1
(43) Pub. Date: Apr. 26, 2012

(54) Current mode switching regulator and control circuit and control method thereof

(75) Inventors: Ting-Hung Wang, Taipei City (TW); Chia-Jung Lee, Toufen Township (TW)

(73) Assignee: Richtek Technology Corporation, R.O.C.

(21) Appl. No.: 13/065,571

(22) Filed: Mar. 24, 2011

(30) Foreign Application Priority Data
Oct. 25, 2010 (TW) 99136333

(51) Int. Cl. G05F 1/618

(52) U.S. Cl. 323/285

(57) ABSTRACT

The present invention discloses a current mode switching regulator, a control circuit of a switching regulator, and a control method of a switching regulator. The switching regulator includes a power stage driven by a driver voltage outputted from a driver circuit. And the power stage switches at least one power transistor to convert an input voltage to an output voltage. The present invention generates an error signal according to a feedback signal related to the output voltage, and adjusts an operation voltage supplied to the driver circuit according to the error signal.

### CROSS REFERENCE

The present invention claims priority to TW 99136333, filed on Oct. 25, 2010.

### BACKGROUND OF THE INVENTION

1. Field of Invention

The present invention relates to a current mode switching regulator and a control circuit and a control method thereof, in particular to such switching regulator, control circuit and control method that adjust the operation voltage of a driver circuit according to a feedback signal related to an output voltage.

2. Description of Related Art

FIG. 1 shows a schematic diagram of a prior art voltage mode switching regulator. As shown in FIG. 1, a PWM controller 11 outputs a PWM signal which controls at least one power transistor of a power stage 12 through a driver circuit 15 to convert an input voltage Vin to an output voltage Vout. The high level of the driver signal outputted from the driver circuit 15 is determined by the operation voltage Vd supplied to the driver circuit 15. A feedback circuit 13 generates a feedback signal related to the output voltage Vout and supplies the feedback signal to the PWM controller 11 so as to generate the PWM signal. The power stage 12 may be a synchronous or asynchronous power conversion circuit such as a buck converter, a boost converter, an inverting converter, or a buck-boost converter, as shown in FIGS. 2A-2J.

When the load circuit is under light load condition, i.e., when the load circuit requires lower amount of current, if the power transistor(s) still operate in normal mode, it may result in higher power loss (including switching loss and transmission loss); hence, the prior art proposes a method for dynamically adjusting the gate driver voltage of the power transistor so as to reduce power consumption. More specifically, the prior art method detects an output current lout and generates an output circuit detection signal. The output circuit detection signal is inputted to the PWM controller 11. When the output current Iout is low, that is, the load circuit is under light load condition, the PWM controller 11 adjusts the operation voltage Vd of the driver circuit 15 to a lower level so that the power transistor(s) in the power stage 12 adaptively operate according to the condition of the load circuit. Consequentially, the power loss is reduced.

For reference of such prior art that detects the output current to adjust the operation voltage Vd of the driver circuit 15, please refer to U.S. Pat. Nos. 7,265,601, 7,345,463, and 7,615,904.

However, if the switching regulator is a multi-phase switching regulator having multiple power stages and corresponding PWM controllers, it becomes very complicated to obtain the output current detection signal because there are multiple output current paths. Under such circumstances, the area of the circuit is often increased and the signal processing is very complicated.

In view of above, the present invention overcomes the foregoing defects by putting forth a current mode switching regulator and a control circuit and a control method that adjust the operation voltage of a driver circuit according to a feedback signal related to an output voltage so that the power transistor is optimally operated.

### SUMMARY OF THE INVENTION

An objective of the present invention is to provide a current mode switching regulator.

Another objective of the present invention is to provide a control circuit for a current mode switching regulator.

Another objective of the present invention is to provide a method for controlling a current mode switching regulator.

To achieve the foregoing objectives, in one aspect, the present invention provides a current mode switching regulator, comprising: a driver circuit receiving a PWM (Pulse width modulation) signal and generating a driver signal, determining a high level of the driver signal according to an operation voltage; a power stage switching at least one power transistor to convert an input voltage to an output voltage and generating a current mode signal according to an inductor current of the power stage; a feedback circuit generating a feedback signal according to the output voltage; an error signal generator generating an error signal according to the feedback signal; and a PWM controller generating the PWM signal according to the error signal and the current mode signal, and adjusting the operation voltage according to the error signal.

In another aspect, the present invention provides a control circuit for a current mode switching regulator, the control circuit generating a pulse width modulation (PWM) signal which switches at least one power transistor of a power stage through a driver circuit to convert an input voltage to an output voltage, wherein the driver circuit determines a high level of a driver signal generated by the driver circuit according to an operation voltage and the power stage generates a current mode signal according to an inductor current of the power stage, the said control circuit comprising: an error signal generator generating an error signal according to a feedback signal related to the output voltage; and a PWM controller generating the PWM signal according to the error signal and the current mode signal, and adjusting the operation voltage according to the error signal.

In the foregoing switching regulator or the control circuit, the PWM controller preferably includes: a PWM signal generator coupled to the error signal generator, the PWM signal generator generating the PWM signal according to the error signal and the current mode signal; and a driver voltage adjustment circuit coupled to the error signal generator, the driver voltage adjustment circuit generating the operation voltage according to the error signal.

The driver voltage adjustment circuit preferably includes a circuit capable of outputting at least two different voltages, such as a selection circuit, a linear voltage regulator capable of changing its reference voltage, or a variable multiple charge pump capable of changing its output-to-input ratio.

The current mode switching regulator may be a multi-phase current mode switching regulator.

In yet another aspect, the present invention provides a method for controlling a current mode switching regulator, wherein the current mode switching regulator switches at least one power transistor of a power stage through a driver circuit to convert an input voltage to an output voltage according to a pulse width modulation (PWM) signal and generates a feedback signal, wherein the driver circuit determines a high level of a driver signal generated by the driver circuit according to an operation voltage, and wherein the power stage generates a current mode signal according to an inductor current, the method comprising: generating an error signal according to the feedback signal; generating the PWM signal according to the error signal and the current mode signal; and adjusting the operation voltage according to the error signal.

In the foregoing method for controlling a current mode switching regulator, the step of adjusting the operation voltage according to the error signal preferably includes: comparing the error signal with a reference voltage; and determining the operation voltage according to the comparison result of the comparator.

The objectives, technical details, features, and effects of the present invention will be better understood with regard to the detailed description of the embodiments below, with reference to the drawings.

### BRIEF DESCRIPTION OF THE DRAWINGS

FIG. 1 shows a schematic diagram of a prior art switching regulator.

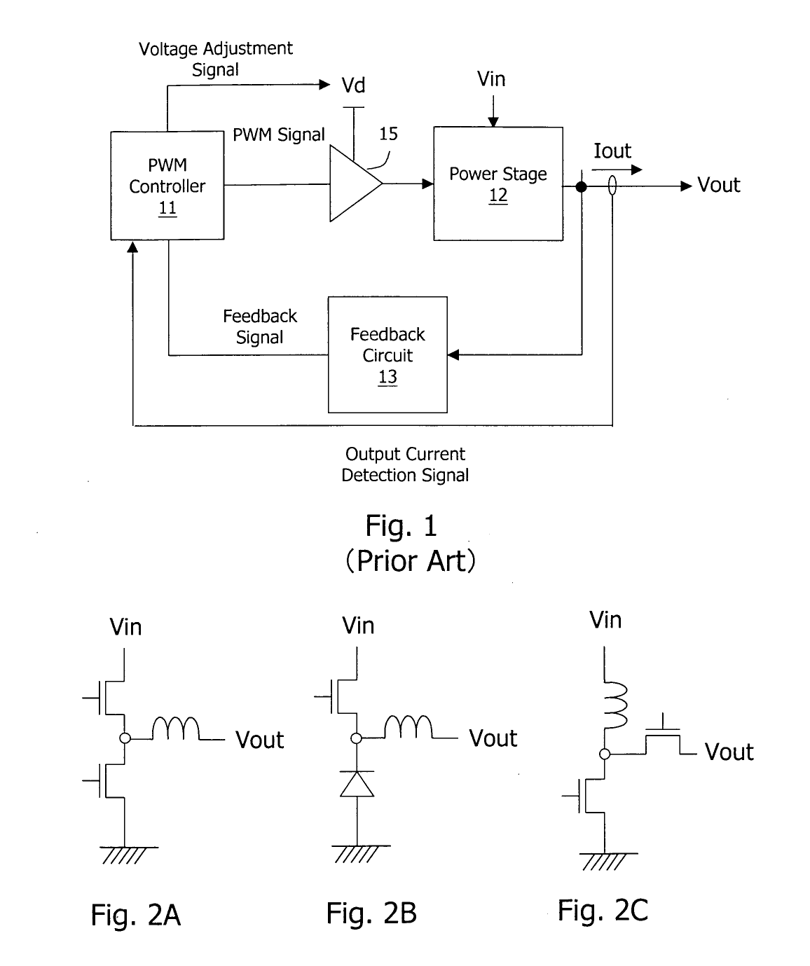

FIGS. 2A-2J show synchronous and asynchronous buck converters, boost converters, inverting converters, and buck-boost converters, respectively.

FIG. 3 shows an embodiment of the present invention, illustrating a basic configuration.

FIG. 4 shows another embodiment of the present invention.

FIG. 4A shows another embodiment of the present invention.

FIG. 5 shows a more specific embodiment of the present invention.

FIGS. 6 and 7 show two embodiments of the driver voltage adjustment circuit 112.

FIG. 8 shows an embodiment of a multi-phase current mode switching regulator applicable of the present invention.

### DESCRIPTION OF THE PREFERRED EMBODIMENTS

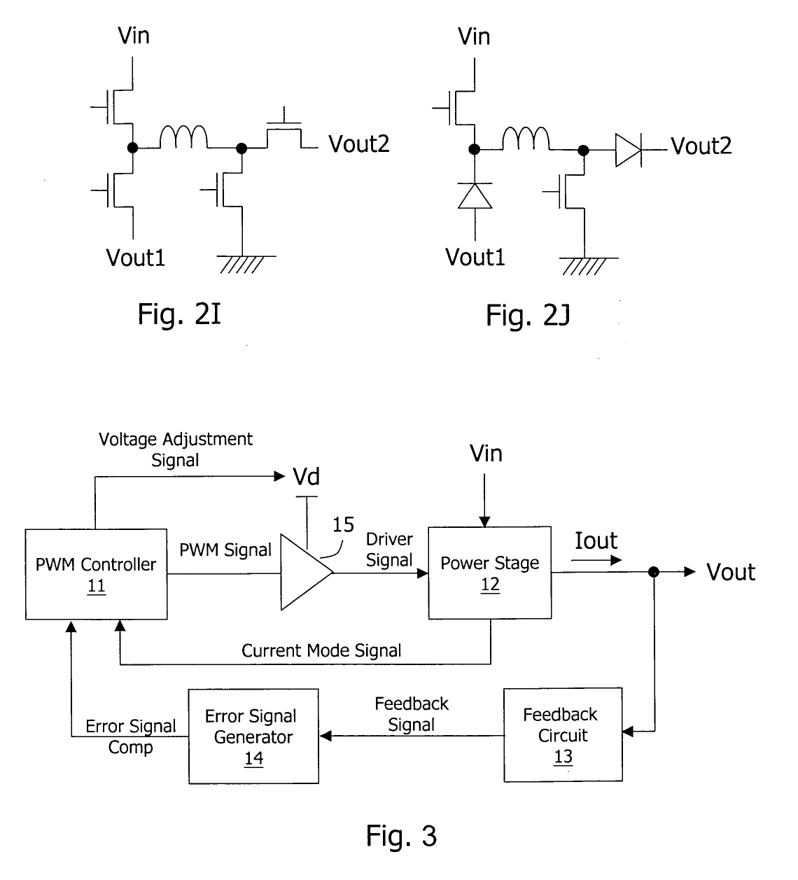

Referring to FIG. 3, a configuration of a current mode switching regulator is shown therein, which also shows an embodiment of the present invention. Unlike a voltage mode switching regulator, the current mode switching regulator 12 directly detects variations in the inductor current of the power stage 12, and generates a current mode signal as an input of the PWM controller 11. The PWM controller 11 compares an error signal COMP with the current mode signal to generate a PWM signal. In the current mode configuration, because the error signal COMP is to be compared with the current mode signal to generate the PWM signal, the error signal COMP needs to be within a level range which matches with the current mode signal. In other words, the level of the error signal COMP contains the information related to the inductor current. In this regard, the present invention can obtain the information related to the output current from the error signal COMP rather than directly from the output terminal. Consequently, the circuit can be simplified.

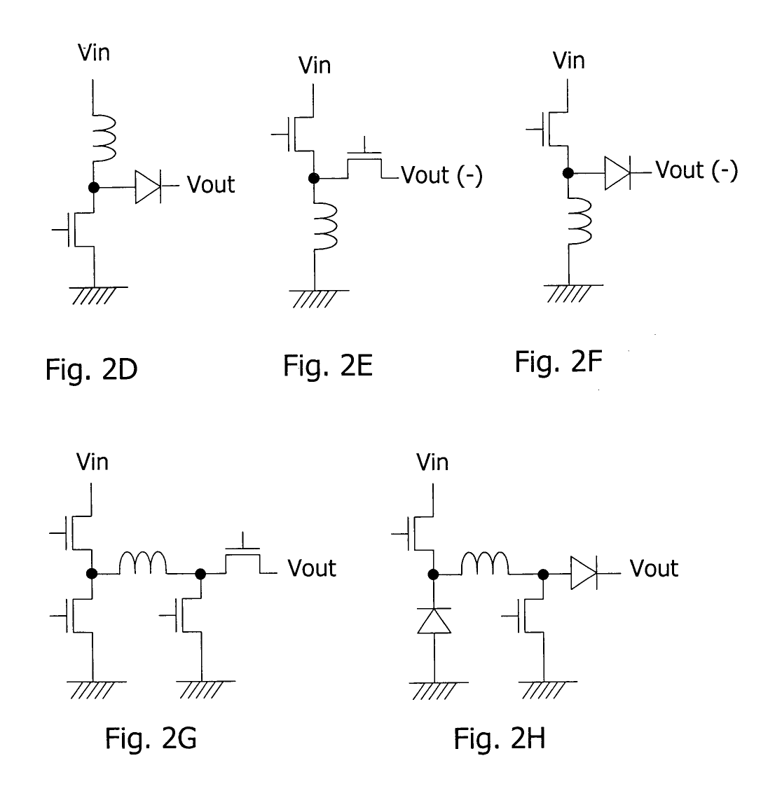

The operation of the circuit of FIG. 3 is described in more detail hereafter. As shown in the figure, the PWM controller 11 outputs a PWM signal to a driver circuit 15. The driver circuit 15 controls at least one transistor of a power stage 12 to convert an input voltage Vin to an output voltage Vout. The high level of the driver signal outputted from the driver circuit 15 is determined by the operation voltage Vd of the driver circuit 15. A feedback circuit 13 generates a feedback signal related to the output voltage Vout, and inputs the feedback signal to an error signal generator 14 for generating an error signal COMP. The parameters of the error signal generator 14 are set such that the level of the error signal COMP properly matches with the current mode signal. The PWM controller 11 receives the error signal COMP and the current mode signal from the power stage 12 so as to generate the PWM signal and a voltage adjustment signal. The power stage 12 may be, for example but not limited to, a buck converter, a boost converter, an inverting converter, or a buck-boost converter in a synchronous or asynchronous mode, as shown in FIG. 2A-2J.

The present invention is different from the prior art in that: in the current mode switching regulator of the present invention, the PWM controller 11 receives the error signal COMP generated by the error signal generator 14, and adjusts the operation voltage Vd of the driver circuit 15 according to the error signal COMP. In comparison with the prior art, the present invention does not need to detect the output current Iout so that the circuit is much less complicated. Particularly, if the current mode switching regulator is a multi-phase switching regulator having multiple power stages and corresponding PWM controllers, the present invention does not need to detect output currents on multiple paths, so it is superior to the prior art. The reason that the variation of the error signal COMP can reflect the variation of the output voltage Iout will be explained in more detail later.

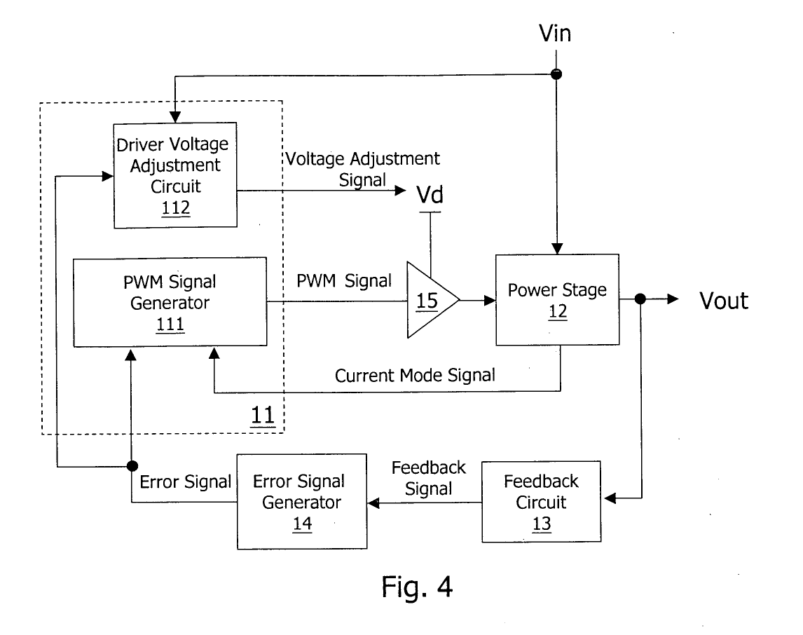

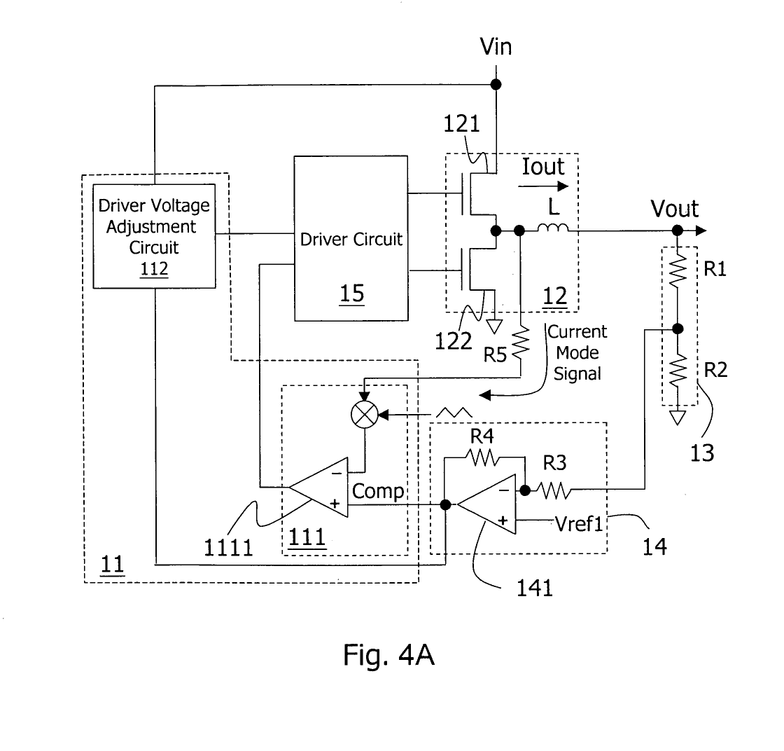

FIG. 4 shows a more specific embodiment of the configuration of the present invention. As shown in the figure, the PWM controller 11 includes a PWM signal generator 111 and a driver voltage adjustment circuit 112. The PWM signal generator 111 coupled to the error signal generator 14 generates the PWM signal as the input of the driver circuit 15 according to the error signal COMP. The driver voltage adjustment circuit 112 coupled to the error signal generator 14 dynamically adjusts the operation voltage Vd according the error signal COMP. In this embodiment, the driver voltage adjustment circuit 112 receives the input voltage Vin and converts it to the operation voltage Vd. The conversion ratio of the input voltage Vin to the operation voltage Vd depends on the error signal COMP.

Referring to FIG. 4A, we will explain why the variation of the error signal COMP can reflect the variation of the output voltage Iout by using this current mode buck switching regulator as an example. However, please note that the present invention is also applicable to boost converters, inverting converters, or buck-boost converters. As shown in the figure, the power stage 12, which is a buck converter, includes an upper power transistor 121, a lower power stage 122 and an inductor L. The feature of the current mode circuit is that the circuit detects an inductor current from the power stage 12 and generates the current mode signal. The current mode signal is converted to a voltage signal through a resistor R5, and the voltage signal is inputted to the PWM controller 11. On the other hand, the feedback circuit 13 generates the feedback signal. The feedback circuit 13 includes two resistors R1 and R2 connected to each other in series. A terminal of the resistor R1 is coupled to the output voltage Vout, and a terminal of the resistor R2 is coupled to the ground. The feedback signal is obtained from a divided voltage on the resistor R2. The error signal generator 14 includes an error amplifier 141, a resistor R3, and a resistor R4. The error signal generator 14 receives the feedback signal from the feedback signal 13, and compares the feedback signal with the reference signal Vref1 to generate the error signal COMP. The values of the resistors (R3, R4) and the reference signal Vref1 should be properly set such that the error signal COMP is at a proper level.

Further referring to FIG. 4A, the PWM controller 11 includes the PWM signal generator 111 and the driver voltage adjustment circuit 112. The PWM signal generator 111 includes a comparator 1111. The current mode signal and a compensation ramp signal are summed together. The sum is inputted to the comparator 1111 to be compared with the error signal COMP for generating the PWM signal. In contrast with the voltage mode, the error signal COMP needs to be compared with the current mode signal (plus the compensation ramp signal) to determine the pulse width of the PWM signal. Accordingly, in the current mode, the level of the error signal COMP needs to be in a range matching with the range of the current mode signal. That is, the level of the error signal COMP contains the information related to the output current. In other words, the variation of the error signal COMP can reflect the variation of the output current Iout.

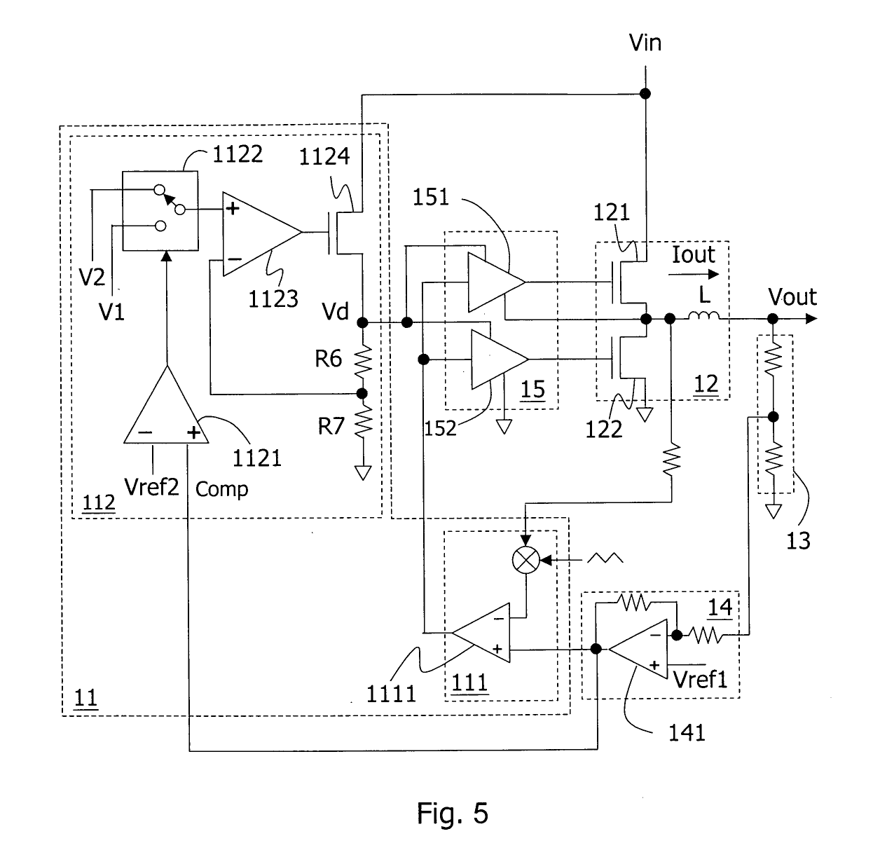

FIG. 5 shows a more specific embodiment of a current mode switching regulator in accordance with the present invention, which shows more details of the driver voltage adjustment circuit 112. This embodiment also takes a buck converter as an example. The details of the feedback circuit 13, the error signal generator 14, and the PWM signal generator 111 are the same as those of FIG. 4A, and are omitted herein.

As shown in figure, The PWM controller 11 includes the PWM signal generator 111 and the driver voltage adjustment circuit 112. The driver voltage adjustment circuit 112 includes a comparator 1121, a selection circuit 1122, an error amplifier 1123, a transistor 1124, a resistor R3, and a resistor R4. The error amplifier 1123, the transistor 1124, the resistor R3, and the resistor R4 form a linear voltage regulator which generates the operation voltage Vd supplied to the driver circuit 15. In the driver voltage adjustment circuit 112, the comparator 1121 receives the error signal COMP from the error signal generator 14 and compares the error signal COMP with a reference signal Vref2. According to the comparison result of the comparator 1121, the selection circuit 1122 designates a voltage signal V1 or V2 as the input of the error amplifier 1123 which serves as a reference voltage. The error amplifier 1123 controls the control terminal of the transistor 1124 according to the comparison between the voltage across the resistor R4 and the reference voltage V1 or V2, and generates the operation voltages Vd on the output node of the linear voltage regulator. The operation voltage Vd is supplied to the upper driver gate 151 and the lower driver gate 152 of the driver circuit 15 so as to respectively drive the upper power transistor 121 and the lower power transistor 122. If the power stage 12 has different number of power transistors (for example, an asynchronous buck converter has only one power transistor), the number of the driver gates in the driver circuit 15 should be correspondingly modified.

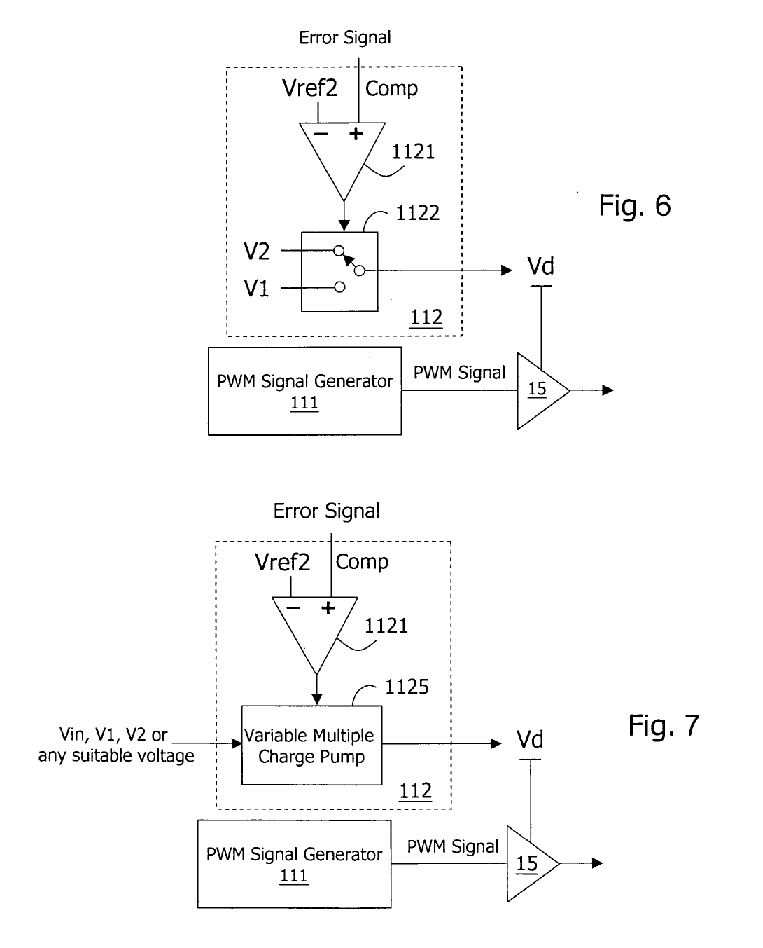

In the foregoing embodiment, the error signal COMP is used to determine the reference voltage of the linear voltage regulator, and the output of the linear voltage regulator is provided as the operation voltage Vd, wherein the input voltage of the linear voltage regulator is Vin. However, the input voltage of the linear voltage regulator is not limited to Vin, and it can be any voltage. In fact, it suffices as long as the driver voltage adjustment circuit 112 can supply two different voltages as the operation voltage Vd, and switches between the two different voltages according to the error signal COMP. For example, FIG. 6 shows another embodiment of the driver voltage adjustment circuit 112 which includes a comparator 1121 and a selection circuit 1122, wherein the selection circuit 1122 selects one of the voltage signals V1 and V2 to be the operation voltage Vd according to the output of the comparator 1121. For another example, FIG. 7 shows another embodiment of the driver voltage adjustment circuit 112 which includes a comparator 1121 and a variable multiple charge pump 1125, wherein the output of the comparator 1121 determines the multiple of the variable multiple charge pump 1125 (i.e., the conversion ratio of the charge pump output voltage to the charge pump input voltage, which does not need to be an integer, neither does it have to be larger than 1) and the output of the variable multiple charge pump 1125 is supplied as the operation voltage Vd. A person skilled in the art can readily conceive various other forms of the driver voltage adjustment circuit 112 based on the spirit of the present invention. All such variations should be included in the scope of the present invention.

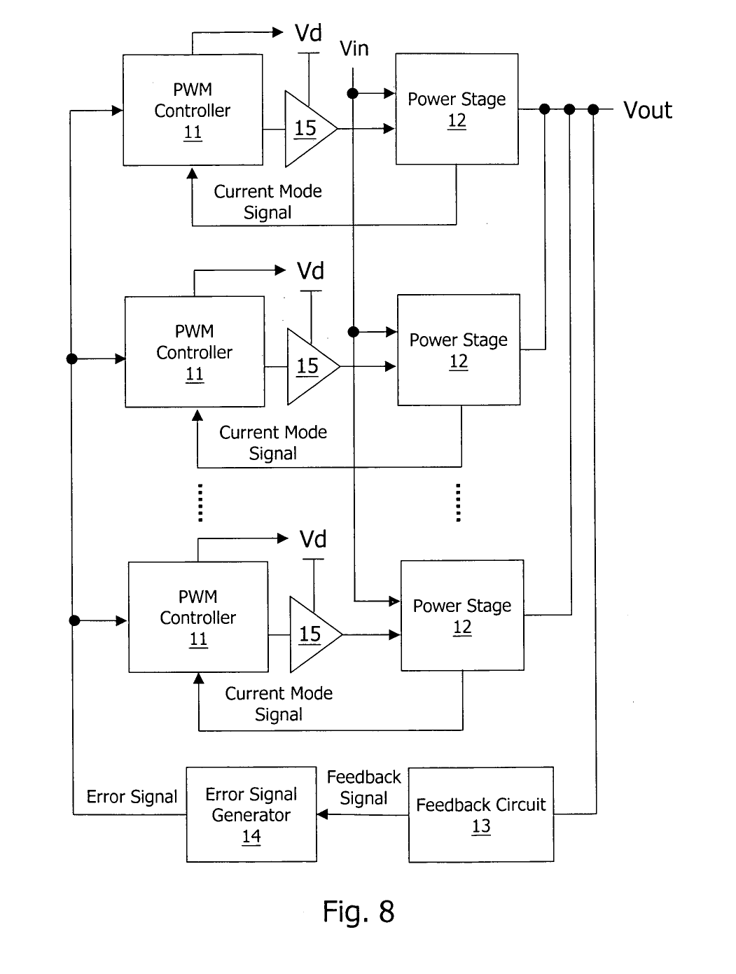

FIG. 8 shows an embodiment of a multi-phase current mode switching regulator applicable of the present invention. As shown in the figure, the regulator comprises a plurality of PWM controllers 11 and a plurality of corresponding power stages 12. In this embodiment, it only has to provide the error signal generated from the error signal generator 14 to each one of the PWM controllers 11. By contrast, in the prior art arrangement which detects output current, it requires multiple output current detection circuits to obtain information of respective phases. Thus, the present invention is much simpler in circuit design and it can reduce the circuit area.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, in all of the embodiments, a device or circuit which does not affect the major functions of the signals, such as a switch, etc., can be added between two circuits illustrated to be directly connected with each other. For another example, the positive and negative terminals of the error amplifier or the comparator are interchangeable, with corresponding amendment to the processing of the output signal. Thus, the present invention should cover all such and other modifications and variations, which should be interpreted to fall within the scope of the following claims and their equivalents.

What is claimed is:

1. A current mode switching regulator, comprising:
a driver circuit receiving a PWM (Pulse Width Modulation) signal and generating a driver signal, the driver circuit determining a high level of the driver signal according to an operation voltage;
a power stage switching at least one power transistor to convert an input voltage to an output voltage and generating a current mode signal according to an inductor current of the power stage;
a feedback circuit generating a feedback signal according to the output voltage;
an error signal generator generating an error signal according to the feedback signal; and
a PWM controller generating the PWM signal according to the error signal and the current mode signal, and adjusting the operation voltage according to the error signal.

2. The current mode switching regulator of claim 1, wherein the PWM controller includes:
a PWM signal generator coupled to the error signal generator, the PWM signal generator generating the PWM signal according to the error signal and the current mode signal; and
a driver voltage adjustment circuit coupled to the error signal generator, the driver voltage adjustment circuit adjusting the operation voltage according to the error signal.

3. The current mode switching regulator of claim 2, wherein the driver voltage adjustment circuit includes:
a comparator comparing the error signal with a reference voltage; and
a selection circuit determining the operation voltage according to the comparison result of the comparator.

4. The current mode switching regulator of claim 2, wherein the driver voltage adjustment circuit includes:
a comparator comparing the error signal with a first reference voltage;
a linear voltage regulator receiving a voltage regulator input voltage and converting the voltage regulator input voltage to the operation voltage according to a second reference voltage; and
a selection circuit determining the second reference voltage according to the comparison result of the comparator.

5. The current mode switching regulator of claim 2, wherein the driver voltage adjustment circuit includes:
a comparator comparing the error signal with a reference voltage; and
a variable multiple charge pump circuit receiving a charge pump input voltage and generating a charge pump output voltage wherein the ratio of the charge pump output voltage to the charge pump input voltage depends on the comparison result of the comparator.

6. The current mode switching regulator of claim 1, wherein the switching regulator is a multi-phase switching regulator comprising a plurality of driver circuits, a plurality of power stages, and a plurality of PWM controllers.

7. A control circuit for a current mode switching regulator, the control circuit generating a pulse width modulation (PWM) signal which switches at least one power transistor of a power stage through a driver circuit to convert an input voltage to an output voltage, wherein the driver circuit determines a high level of a driver signal generated by the driver circuit according to an operation voltage and the power stage generates a current mode signal according to an inductor current of the power stage, the said control circuit comprising:
an error signal generator generating an error signal according to a feedback signal related to the output voltage; and
a PWM controller generating the PWM signal according to the error signal and the current mode signal, and adjusting the operation voltage according to the error signal.

8. The control circuit for a current mode switching regulator of claim 7, wherein the PWM signal generator includes:
a PWM signal generator coupled to the error signal generator, the PWM signal generator generating the PWM signal according to the error signal and the current mode signal; and
a driver voltage adjustment circuit coupled to the error signal generator, the driver voltage adjustment circuit generating the operation voltage according to the error signal.

9. The control circuit for a current mode switching regulator of claim 8, wherein the driver voltage adjustment circuit includes:
a comparator comparing the error signal with a reference voltage; and
a selection circuit determining the operation voltage according to the comparison result of the comparator.

10. The control circuit for a current mode switching regulator of claim 8, wherein the driver voltage adjustment circuit includes:
a comparator comparing the error signal with a first reference voltage;
a linear voltage regulator receiving a voltage regulator input voltage and converting the voltage regulator input voltage to the operation voltage according to a second reference voltage; and
a selection circuit determining the second reference voltage according to the comparison result of the comparator.

11. The control circuit for a current mode switching regulator of claim 8, wherein the driver voltage adjustment circuit includes:
a comparator comparing the error signal with a reference voltage; and
a variable multiple charge pump circuit receiving a charge pump input voltage and generating a charge pump output voltage, wherein the ratio of the charge pump output voltage to the charge pump input voltage depends on the comparison result of the comparator.

12. A method for controlling a current mode switching regulator, wherein the current mode switching regulator switches at least one power transistor of a power stage through a driver circuit to convert an input voltage to an output voltage according to a pulse width modulation (PWM) signal and generates a feedback signal, wherein the driver circuit determines a high level of a driver signal generated by the driver circuit according to an operation voltage, and wherein the power stage generates a current mode signal according to an inductor current, the method comprising:
generating an error signal according to the feedback signal;
generating the PWM signal according to the error signal and the current mode signal; and
adjusting the operation voltage according to the error signal.

13. The method for controlling a current mode switching regulator of claim 12, wherein the step of adjusting the operation voltage according to the error signal includes:
comparing the error signal with a reference voltage; and
determining the operation voltage according to the comparison result of the comparator.

14. The method for controlling a current mode switching regulator of claim 12, wherein the step of adjusting the operation voltage according to the error signal includes:
providing a linear voltage regulator which receives a voltage regulator input voltage and converts the voltage regulator input voltage to the operation voltage according to a first reference voltage; and
comparing the error signal with a second reference voltage to determine the first reference voltage.

15. The method for controlling a current mode switching regulator of claim 12, wherein the step of adjusting the operation voltage according to the error signal includes:
providing a variable multiple charge pump circuit which receives a charge pump input voltage and generates a charge pump output voltage; and
comparing the error signal with a reference voltage to determine the ratio of the charge pump output voltage to the charge pump input voltage.
